(19) United States
(12) Patent Application Publication
(10) Pub. No.: US 2015/0199311 A1
(43) Pub. Date: Jul. 16, 2015

(54) EXTENSIBILITY FRAMEWORK SYSTEM AND METHOD

(71) Applicant: Digital River, Inc., Minnetonka, MN (US)

(72) Inventors: Daniel John CHARBONNEAU, Chanhassen, MN (US); Johnathan MEEHAN, Shannon County Clare (IE)

(21) Appl. No.: 14/596,029

(22) Filed: Jan. 13, 2015

Related U.S. Application Data
(60) Provisional application No. 61/926,760, filed on Jan. 13, 2014.

(51) Int. Cl. G06F 17/22; G06Q 30/00

(52) U.S. Cl. CPC G06F 17/2247; G06Q 30/00

(57) ABSTRACT

An extensibility framework system and method is disclosed. An extensibility framework system and method provides a self-service portal and console for web merchants to add features to web sites hosted by a full service e-commerce system. Web page add-ons allow web site owners to enhance their pages with links, widgets, small applications and other features. The disclosed extensibility framework system and method allows a client/site content manager to create an add-on to the site that will display a feature, or capture and deliver data to external systems. A page is presented to the client to define and configure the feature. The definition is stored in XML in a database and is used to dynamically build a page and data structure for collecting the required data. Add-ons may be of display type, integration (feed) type, a combination display-feed type, and trigger type.

This application claims the benefit of U.S. Provisional Patent Application No. 61/926,760 filed on 13 Jan. 2014, titled “Extensibility Framework,” which is incorporated herein by reference.

### FIELD OF THE INVENTION

The present disclosure relates generally to the provision of e-commerce services. The disclosure more particularly relates to a self-service portal for allowing clients of an e-commerce system to add features to their e-commerce implementation without the involvement of e-commerce system developers.

### BACKGROUND OF THE INVENTION

Web marketers have discovered the value of social media, customer reviews and web marketing in driving customers to their site. Many features that allow social connections and reviews have been created by third parties who may provide code that web developers may use to add these features to their site. However, this typically requires development and deployment resources. What is needed is a self-service system and method that will allow a user (e.g. web site content manager) to add these features to a web site without developer intervention. An extensibility framework system and method described herein offers a solution to this problem and offers other benefits over the prior art.

### BRIEF SUMMARY

Web page add-ons allow web site owners to enhance their pages with links, widgets, small applications and other features. The disclosed extensibility framework system and method allows a client/site content manager to create an add-on to the site that will display a feature, or capture and deliver data to external systems. A page is presented to the client to define and configure the feature. The definition is stored in XML in a database and is used to dynamically build a page and data structure for collecting the required data.

In one embodiment, a self-service web portal in a global e-commerce system is described. The portal allows web page developers to choose from third party features, receive a dynamically generated definition page with which they may enter feature attributes, and pull that information into the client page. Features are displayed when the shopper navigates to the client page where the feature is displayed. Exemplary features include cart recovery, reviews, chat, customer relationship management, analytics, product feeds, social marketing and product recommendations.

In another embodiment, the self-service web portal in a global e-commerce system allows the user to set up and configure “feeds,” or the delivery of information to various groups by defining data requirements and using integration services to create an API to deliver the data feed.

In another embodiment, the self-service web portal in a global e-commerce system allows the user to set up and configure triggers that will, upon an event, send client-defined information to the client.

### BRIEF DESCRIPTION OF THE DRAWINGS

FIG. 1 provides a conceptual model of an extensibility framework system and method.

FIG. 2 is a class diagram for Extensible Plugin and related classes.

FIG. 3 is an exemplary screen shot of an add-on selection page.

FIG. 4 is an exemplary screen shot of an advanced settings page for configuring an add-on.

FIG. 5 is an exemplary screen shot of an advanced settings page for configuring runtime details for a new page.

### DETAILED DESCRIPTION

An extensibility framework system and method allows a third party to create add-ons (e.g. plug-ins or widgets) which may be dynamically added to a global e-commerce system command console for placement on merchant web pages. The add-ons manage third party behaviors which may be injected into storefront workflows by a site's content manager. Third parties may add their plug-ins to the e-commerce system, dynamically creating a data structure in the data base.

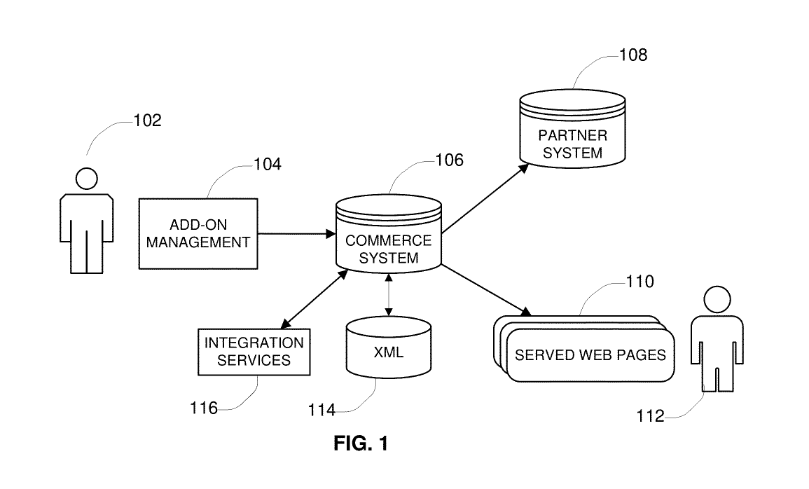

FIG. 1 is an exemplary, high level conceptual model for an extensibility framework. An add-on manager or content manager 102 for a merchant web site accesses a self-service console of an e-commerce system 106 and creates the attributes for the add-on in an add-on management module 104. Add-on code may be selected from a third party database 108. Add-ons are typically developed and supplied by third party partners. The extensibility framework system and method allows a content manager to select and configure add-ons, and using that information, automatically create the page rendering and data collection capabilities for the add-on. Once created, the add-on is deployed on the merchant's web page 110 where it is displayed as a function for shopper 112 to use, or will be used by the system to feed data from one system to another. Within the e-commerce system, page configuration details may be stored in XML format in a local database 114, and an integration services module 116 provides the means of data transfer when the add-on requires a data feed through an API, bulk job processing or a trigger to provide a record to a third party.

The framework allows for the addition of three types of add-ons: (1) display add-ons, which provide a display component that is presented to a shopper when the shopper visits a site (examples: facebook like, follow and send); (2) integration add-ons, which send data (e.g. product/order/fulfillment data) from the e-commerce system to the third party, which can be used by the third party for marketing/analytics/recommendation purposes, for example, and which use an integration framework and jobs for providing the data to the third party; and (3) a display and integration combination whereby the add-on has both a display and an integration data feed component.

The e-commerce system provides hosted web pages with commerce functionality. Clients of the e-commerce system may wish to include an add-on on a page on their site. The client selects an add-on and a page is created from XML processes which allow the client to configure the add-on for their site. The system automatically creates the code for the pages for display and data collection and the data structures required, and in the case of feed add-ons, creates the integration necessary for the system to send data to a third party. Configuration details are stored in the data base. When the shopper navigates to the page on which the add-on resides, javascript renders the whole page first, and then a web-development technique such as ajax is used to call back into the system to look for extensibility features. If such features have been configured for the site, the system takes all the information, pulls it into the page, and adds additional javascript and html for the displayed feature.

The process of creating an add-on in an extensibility framework system and method begins when a merchant/partner defines and requests his/her add-on in the global e-commerce system. The client may choose an add-on and configure it for their site. The add-on uses the extensibility framework to display, using javascript to auto deploy content; feed, by autocreating integration processes, or triggers, through automatically hooking into trigger points.

As the content manager chooses the add-on, a page is rendered which allows the content manager to configure the add-on by providing fields, data points, and any other features that must be captured. Some add-ons may have mandatory fields that will be included in additional to the ones provided by the content manager, including where on the page you want to put the attributes and any other information required to set up the page. The framework may store the information in XML format and then dynamically create a dataset and build a page specific to the add-on. Further processing may be required depending on the type of add-on selected. For example, a display item may require code to create the display (e.g. HTML to create a button on a page). A feed, which moves data from one system to another, may require additional set up with integration services. Triggers require the definition of a particular event or action (the trigger) that will initiate a data transfer. For example, a shopper may confirm an order and as the navigation moves from confirmation to thank you, order information is transmitted to the sales force.

Once the content manager has set up the add-on, the framework dynamically includes the add-on on the client's site. A build page is created, to which add-on javascript is injected to create a display page on which add-ons are dynamically pulled for display. When the add-on has been deployed, the javascript renders the whole page first, and then a web-development technique such as ajax is used to call back into the system to look for extensibility features. If such features have been configured for the site, the system takes all the information, pulls it into the page, and adds additional javascript and html for the displayed feature.

Add-on configuration management consists of a number of elements. As was described above, a screen is available in a self-service console storefront functionality to manage add-ons. A code section displaying this page has the ability to parse PluginConfiguration.xml instance. Table 1 illustrates sample manage Add-Ons JSP.

TABLE 1
Sample Manage Add-Ons JSP Rending Plugin Logic

FOR each attribute defined in the PluginConfiguration.XML
IF attribute.type == text THEN
<input type=“text” id=“<c:out value=”${status.expression}“/>”
name=“<c:out value=”${status.expression}“/>” value=“<c:out
value=”${attribute.value}“/>” data-required=“${attribute.required}” />
ENDIF
// Other IF type checks for textarea, url, checkbox, etc.
ENDFOR

For the Add-On configuration, the data defining an add-on is represented as XML documents which are defined against XSD (PluginConfiguration.xsd & PluginConfigurationRuntime.xsd). Both the XML documents and the site specific add-on configuration details are stored in a group of tables. The configuration details are stored in Entity-Attribute-Value tables. Database scripts run to automatically create the configuration tables.

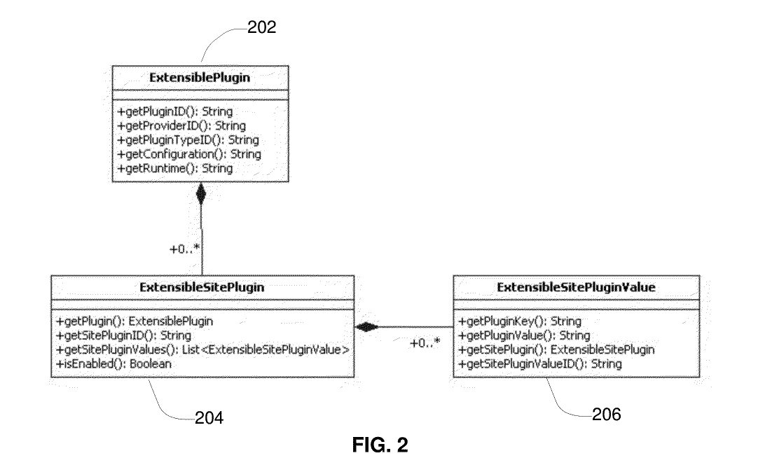

A PluginConfiguration XSD describes how an add-on can be configured and a PluginConfiguration XML instance describes how a particular add-on should be configured. FIG. 2 illustrates a PluginDomainModel and its classes, ExtensiblePlugin 202, ExtensibleSitePlugin 204 and ExtensibleSitePluginValue 206. These classes are described in Table 2 below.

TABLE 2
PluginDomainModel

| CLASS | DESCRIPTION |
|---|---|
| ExtensiblePlugin | Defines an add-on in terms of high level data, |
| | including (1) Provider ID, and (2) plugin type ID. |
| | It has configuration and runtime properties. |
| | Configuration is stored as SML and maps to a |
| | pluginConfiguration. Runtime is stored as |
| | XML and maps to a |
| | pluginConfigurationRuntime |
| ExtensibleSitePlugin | Defines the relationship of an |
| | ExtensiblePlugin and a site, where this |
| | relationship can be characterized by (1) |
| | “existing” and (2) being enabled |
| ExtensibleSitePluginValue | Provides access to plugin values for a specific |
| | site. A PluginConfigurationInfo |
| | provides high level plugin info like provider |
| | name, provider url, provider image, etc. and a |
| | collection of zero or more |
| | ConfigurationSectionInfos. A |
| | ConfigurationSectionInfo is a way of |
| | grouping zero or more |
| | ExtensibleConfigurationInfo's |
| | together, where an |
| | ExtensibleConfigurationInfo defines a |
| | generic type that can represent a configuration |
| | attribute. In addition to this generic behavior, a |
| | mechanism was also needed to define a |
| | relationship between a add-on and an integration, |
| | This has been achieved by the type |
| | PluginIntegrationInfo, for which a |
| | PluginConfigurationInfo can have zero |
| | or more. A PluginIntegrationInfo |
| | consists of one element, a process ID. |

An ExtensibilityProfileAction may be considered as the starting point to load or save the add-on related data. ExtensibilityProfileAction.java handles two types of actions: load and save. The load ( ) method comprises 2 method calls: populateConfiguration ( ) and populate Integrations ( ). Similarly, save ( ) method comprises three method calls: saveIntegrations ( ), saveFiles ( ) and saveConfigurations ( ).

The PluginService interacts with the Plugin Data Model to manage PluginConfigurations. These methods are described in the table below.

TABLE 3
PlugInService Calls

| | |
|---|---|
| PluginService#Get | Returns the JAXB generated type |
| | PluginConfiguration; populated with |
| | the baseconfiguration info and is populated |
| | with the site specific configuration values (if |
| | they were previously set). |
| PluginService#save | Accepts a PluginConfiguration |
| | instance and saves in the plugin data model. |

A feed, or integration add-on may be executed via batch processing. A batch job may invoke methods for export job management with all the required parameters. For example, types BulkExportJobManager and ExtensibleBulkExportJobManager may be used. These initialize the method which checks the passed parameters for validity, terminating execution upon failure or request for usage information. Following, a method handles the creation and publication of jobs.

The environment in which an extensibility framework system and method operates is necessarily composed of a number of electronic components. E-commerce systems are hosted on servers located in data centers that are accessed by networked (e.g. internet) users through a web browser on a remote computing device and/or an API request created by the client website. One of ordinary skill in the art will recognize that a “host” is a computing system that is accessed by a user, usually over cable or phone lines, while the user is working at a remote location. The system that contains the data and functionality is the host, while the computing system at which the user sits is the remote system. Software modules may be referred to as being “hosted” by a server. In other words, the modules are stored in memory in the system for execution by a processor. The various components of an e-commerce service provider include modules performing catalog, merchandising, shopping cart, pricing, payments, tax, and fulfillment, among others. The e-commerce application may further comprise application interfaces, application programming interfaces (APIs), a commerce engine, services, third party services and solutions, and client and partner integrations. The application interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, users may access the client website from a computer workstation or server, a desktop or laptop computer, or a mobile device. The client may then access the e-commerce system using APIs, which provide communications from the client's web servers to the e-commerce system data center application servers. A commerce engine comprises a number of components required for online shopping, for example, modules with instructions stored in memory that when executed by the processor perform functions related to customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wish list, saved cart, entity, security, throttle and more). Third party services and solutions may be contracted with to provide specific services, such as address validation, payment providers, tax and financials. Client integrations may include fulfillment partners, client fulfillment systems, and warehouse and logistics providers.

As is well known in the art, an electronic computing device, such as a server, laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on a sub-component of the computer or device system such as a keyboard or disk drive, but may also be electronic communications between devices connected by a network, such as a wide area network (e.g. the Internet) or a local area network. The memory may include random access memory (RAM) or similar types of memory. Software applications stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired.

A secondary storage device may include a hard disk drive, floppy disk drive, CD-ROM drive, DVD-ROM drive, or other types of non-volatile data storage, and may correspond with the various equipment and modules shown in the figures. The processor may execute the software applications or programs either stored in memory or secondary storage or received from the Internet or other network. The input device may include any device for entering information into computer, such as a keyboard, joy-stick, cursor-control device, or touch screen. The display device may include any type of device for presenting visual information such as, for example, a computer monitor or flat-screen display. In the context of the presently described invention, the output device may include any type of device used to provide information in machine-readable form. Although the computer, computing device or server has been described with various components, it should be noted that such a computer, computing device or server can contain additional or different components and configurations.

### Example

### Google Merchant

An example serves to illustrate the extensibility framework system and method. Google Merchant is a tool that helps a merchant upload store and product data to Google and make it available to various Google services, including Google Shopping. Merchant web sites may wish to include Google merchant on their e-commerce system-hosted web sites as a way to share store and product data across shopping networks. The integration would consist of FTPing an xml file containing catalog data to a Google FTP location.

The merchant content manager logs into the command console, chooses Add-Ons functionality, and the Google Merchant Center from the list of Add-Ons. The Google merchant add-on functionality is simply a bulk export job that will be scheduled to run daily. It involves the sharing of data between two disparate systems. Multiple integration processes of the same type can be achieved by utilizing add-on process configurations. The Add-on applies additional data translation and sends the data to an endpoint different from the parent. Additional handlers, filters and miscellaneous configuration details to not affect the output. In this disclosure, handlers decorate product beans and their sub-types, by adding additional information to the beans. Filters filter complete products from being exported, so handlers act at the product property level and filters act at the product level. Each process has a default list of associated handlers and filters, however, additional handlers and filters may be added to a given process.

The attributes of a bulk export job may be maintained using a snippet of XML inside a text area. Various attributes may be included, such as whether a full image URL is exported (true or false); whether the latest version or the deployed version of a product should be exported; whether retired products should be exported; and formatting. Additional Product Export handlers may be added or removed by updating the process configuration version extended attributes to contain the attribute to be added or removed.

The Add-on integration consists of a NoOp (no transport/xlst) base/parent integration and multiple child integrations. Filters are applied to the Parent must generate a data set that is “wide” enough so as to be useful to its dependent child integrations (Add-Ons). The Add-Ons are responsible for filtering out unwanted data, which is accomplished via their XSLT(s). Each child integration represents an Add-On. Integrations with the e-commerce system may be hidden from the content manager. When the Add-On is created by the content manager, the extensibility framework applies a series of defaults to create the integration, and to dynamically schedule the process.

### Example

### Display Item AddThis

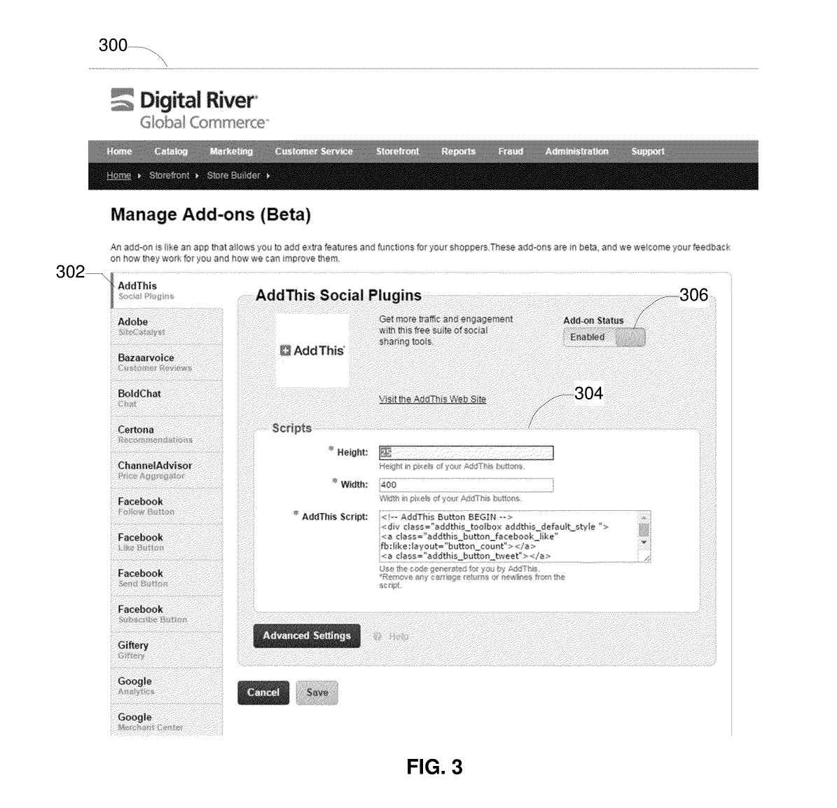

AddThis is a sharing feature that allows users to share content across social media sites. Online merchants know that word of mouth, reviews, and shares drive sales and may wish to take advantage of the positive “advertising” that satisfied customers can provide. A client/content manager navigates to the Extensibility Framework console screen for Add-Ons (FIG. 3) and selects “AddThis” from the list of add-ons 302. The content manager uses the available fields to configure the add-on for display on the merchant's page 304 and enables the add-on for deployment 306. When the add-on is deployed, a script is run that tells the system what information is required for setup and configuration; what must be displayed on the configuration page. Table 4 provides exemplary XML that may be used for this purpose.

TABLE 4
Exemplary Add-On Configuration Script

```
<?xml version=“1.0” encoding=“UTF-8”?>
<PluginConfiguration
xmlns=“http://extensibility.digitalriver.com/PluginConfiguration”
xmlns:xsi=“http://www.w3.org/2001/XMLSchema-instance”>
  <providerID>AddThis</providerID>
  <pluginTypeID>Social Plugins</pluginTypeID>
  <enabled>false</enabled>
  <pluginDescription>Get more traffic and engagement with this free
suite of social sharing tools.</pluginDescription>
  <providerURL>http://www.addthis.com/social-plugins</providerURL>
  <imageURL>extensibility/addthis-socialplugins-logo.png</imageURL>
  <ConfigurationSection>
    <sectionID>Scripts</sectionID>
    <BaseAttribute xsi:type=“ExtensibleAttributeInfo”>
      <key>EXT_AddThis_SocialPlugins_Height</key>
      <value>25</value>
      <type>text</type>
      <label>Height</label>
      <hintText>Height in pixels of your AddThis buttons.</hintText>
      <regex>\hat{ }[0-9]*$</regex>
      <required>true</required>
    </BaseAttribute>
    <BaseAttribute xsi:type=“ExtensibleAttributeInfo“>
      <key>EXT_AddThis_SocialPlugins_Width</key>
      <value>400</value>
      <type>text</type>
      <label>Width</label>
      <hintText>Width in pixels of your AddThis buttons.</hintText>
      <regex>\hat{ }[0-9]*$</regex>
      <required>true</required>
    </BaseAttribute>
    <BaseAttribute xsi:type=“ExtensibleAttributeInfo”>
      <key>EXT_AddThis_SocialPlugins_Script</key>
      <value/>
      <type>textarea</type>
      <label>AddThis Script</label>
      <hintText>Use the code generated for you by AddThis. *Remove
any carriage returns or newlines from the script.</hintText>
      <regex/>
      <required>true</required>
    </BaseAttribute>
  </ConfigurationSection>
</PluginConfiguration>
```

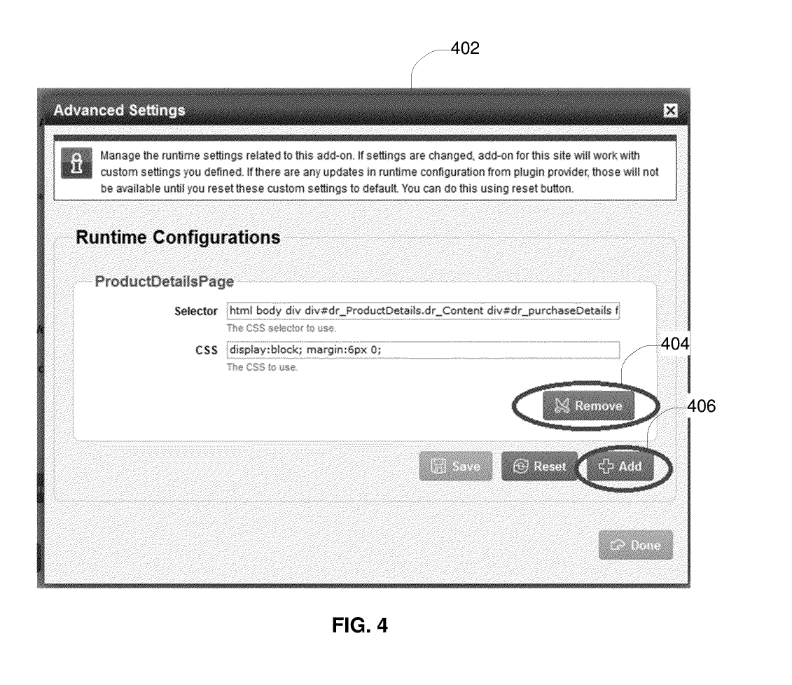

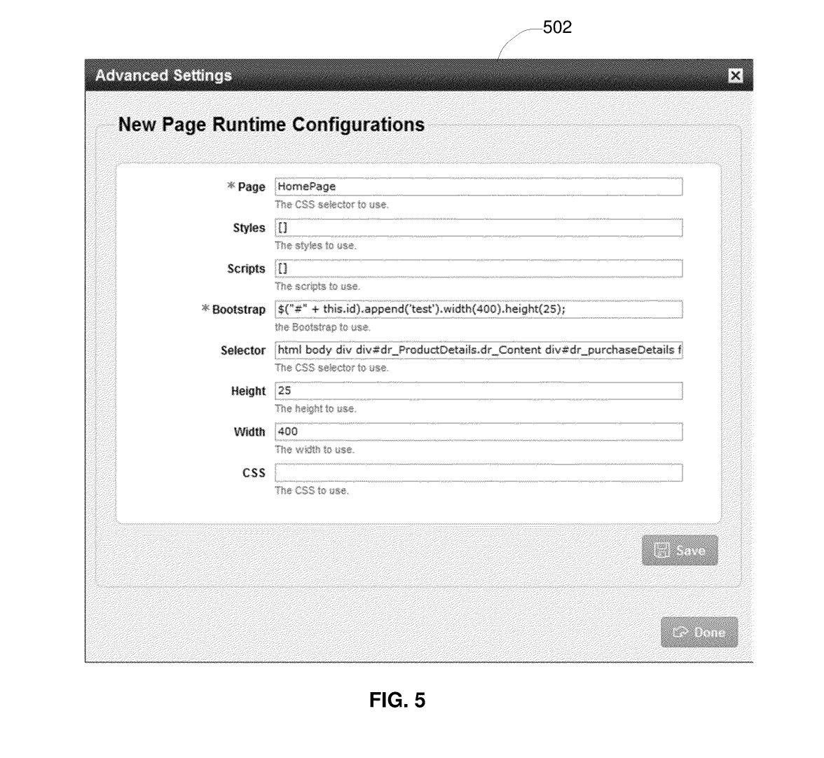

The script renders a page that allows the client to configure the add-on for their site. A data structure is dynamically created for the specific data set. FIGS. 4 and 5 illustrate configuration pages for managing the runtime configurations for the add-on. The user may change, remove or add runtime details. FIG. 5 illustrates some advanced runtime settings 502 that may be configured by the user. Runtime settings available may be created dynamically depending on the type of add-on selected.

When the page is deployed and requested by a user, the build page is rendered and a script is run to determine whether the page contains an add-on. Table 5 provides an exemplary script used for this purpose. If an add-on has been configured for the site, a Runtime script adds the add-on. Table 6 provides an exemplary Runtime script.

TABLE 5
Determine Add-on

```
<%@ page contentType=“text/html; charset=UTF-8” %>
<%@ taglib uri=“/tlds/marketmaker.tld” prefix=“dr” %>
<%@ taglib uri=“/tlds/struts-bean.tld” prefix=“bean” %>
<%@ taglib uri=“/tlds/struts-logic.tld” prefix=“logic” %>
<%@ taglib uri=“/tlds/struts-html.tld” prefix=“html” %>
<%@ taglib uri=“/tlds/jdo.tld” prefix=“jdo” %>
<%@ taglib uri=“/WEB-INF/tlds/request.tld” prefix= “req” %>
<%@ taglib uri=“/tlds/string.tld” prefix=“str” %>
<dr:page>
<dr:definePlugins />
<logic:notEmpty name=“plugins”>
<%-- // Start SR 300284073 --%>
<logic:iterate id=“plugin” name=“plugins” >
  <logic:notEmpty name=“plugin” property=“head”>
    <bean:write name=“plugin” property=“head” filter=“false”/>
  </logic:notEmpty>
</logic:iterate>
<%-- // End SR 300284073 --%>
<script>
var context = {request:{<logic:iterate id=“rl” name=“requestInfo”><logic:notEqual name=“rl”
property=“key” value=“cardNumber”><logic:notEqual name=“rl” property=“key”
value=“cardSecurityCode”>“<bean:write name=“rl”property=“key” ignore=“true” filter=“true”
/>”:“<bean:write name=“rl” property=“value” ignore=“true” filter=“true”
/>”,</logic:notEqual></logic:notEqual></logic:iterate>“x”:“x”}};
(function(window, $, undefined) {
var plugins = {
  <logic:iterate id=“plugin” name=“plugins” indexId=“pluginCount”>
    pi${pluginCount}: {
      id:“piEl${pluginCount}”,
      scripts:[${plugin.scripts}],
      styles:[${plugin.styles}],
      bootstrap:“<str:replace replace=“\n”
with=“\\”><str:escape>${plugin.bootstrap}</str:escape></str:replace>”,
      values:{<logic:iterate id=“sitePluginValue”
collection=“${plugin.sitePluginVersion.sitePluginValues}”><logic:equal name=“sitePluginValue”
property=“publicValue”
value=“true”>“${sitePluginValue.pluginKey}”:“<str:escape>{sitePluginValue.pluginValue}</str:escape>”,<
/logic:equal></logic:iterate>“x”:“x”},
      selector:“${plugin.selector}”,
      height:“${plugin.height}”,
      width:“${plugin.width}”,
      css:“${plugin.css}”
    }
  <logic:lessThan name=“pluginCount” value=“${pluginsCount - 1}”>,</logic:lessThan>
  </logic:iterate>
};
var ClientSideJS = (function ( ) {
  var setElements = function(obj) {
    if(obj.selector !== “ ” && obj.selector !== undefined) {
      if($(obj.selector).is(obj.selector)) {
        var elemStyle = “style=‘height: ” + obj.height + “px; width: ” + obj.width + “px;” + ((obj.css !== “ ”
&& obj.css !== undefined) ? obj.css : “ ”) + “ ”;
        $(obj.selector).after(‘<span id=“‘ + obj.id + ’”‘ + elemStyle + ’><\/ span>’);
        if(obj.width >= 200 && obj.height >= 200) {
          $(“#” + obj.id).css({ “background-image” : “url(<dr:url template=“true”
rscName=“ext_loader_default_large.gif” />)”, “background-repeat” : “no-repeat“, “background-position” :
“center” });
        } else {
          $(“#” + obj.id).css({ “background-image” : “url(<dr:url template=“true”
rscName=“ext_loader_default_small.gif” />)”, “background-repeat” : “no-repeat”, “background-position” :
“center” });
        }
      }
    }
  };
  var setStyles = function(styleArray) {
    if(styleArray !== “ ” && styleArray !== undefined) {
      var styleDomElem = “ ”;
      for(var i = 0; i < styleArray.length; i++) {
        styleDomElem += ‘<link type=“text/css” rel=“stylesheet” href=“’ + styleArray[i] + ‘”\/>’;
      }
      $(“head”).append(styleDomElem);
    }
  };
  var setScripts = function(scriptArray) {
    if(scriptArray !== “ ” && scriptArray !== undefined) {
      var scriptDomElem = “ ”;
      for(var i = 0; i < scriptArray.length; i++) {
        scriptDomElem += ‘<script type=“text/javascript” src=“’ + scriptArray[i] + ‘”><\/script>’;
      }
      $(“body”).append(scriptDomElem);
    }
  };
  var clearLoading = function(obj) {
    if(obj.selector !== undefined && obj.selector !== “ ”) {
      if($(obj.selector).is(obj.selector)) {
        $(“#” + obj.id).css(“background-image”, “none”);
      }
    }
  };
  var activate = function(obj) {
    for(var prop in obj) {
      try {
        if(obj.hasOwnProperty(prop)) { (new Function(obj[prop].bootstrap)).call(obj[prop]);
clearLoading(obj[prop]); }
      } catch(err) {
        if (window.console) { console.log(“Plugins Bootstrap Error: ” + err); }
      }
    }
  };
  return {
    init: function(obj) {
      for(var prop in obj) {
        if(obj.hasOwnProperty(prop)) {
          setElements(obj[prop]);
          setStyles(obj[prop].styles);
          setScripts(obj[prop].scripts);
        }
      }
      activate(obj);
    }
  };
})( );
$(function ( ) { ClientSideJS.init(plugins); });
}(window, jQuery));
</script>
<logic:present parameter=“Env”><bean:parameter id=“jsEnv” name=“Env”/></logic:present>
<logic:present parameter=“Locale”><bean:parameter id=“jsLocale” name=“Locale”/></logic:present>
<logic:present parameter=“SiteID”><bean:parameter id=“jsSiteID” name=“SiteID”/></logic:present>
<logic:present parameter=“productID”><bean:parameter id=“jsProductID”
name=“productID”/></logic:present>
<logic:present parameter=“reqID”><bean:parameter id=“jsReqID” name=“reqID”/></logic:present>
<logic:present parameter=“id”><bean:parameter id=“jsId” name=“id”/></logic:present>
<script>
var pageData = { };
pageData.product = ( function( ){
var productJSON;
var productJSONLoaded = false;
var listofProductDetailsFunctions = [ ];
var requestedForLoad = false;
var hostName = “<bean:write name=“request” property=“serverName” filter=“true”/>”;
var portNumber = “<bean:write name=“request” property=“serverPort” filter=“true”/>”;
var protocol = “<bean:write name=“request” property=“scheme” filter=“true”/>”;
var environment = “<bean:write name=“jsEnv” filter=“true” ignore=“true”/>”;
var locale = “<bean:write name=“jsLocale” filter=“true” ignore=“true”/>”;
var siteID = “<bean:write name=“jsSiteID” filter=“true” ignore=“true”/>”;
var productID = “<bean:write name=“jsProductID” filter=“true” ignore=“true”/>”;
var urlForProductDetails = protocol +“://”+hostName
+“:”+portNumber+“/store?Action=DisplayProductDetailsJSONPage”;
if(environment != null){
urlForProductDetails = urlForProductDetails+“&Env=”+environment;
```

}

if(locale != null){
urlForProductDetails = urlForProductDetails+“&Locale=”+locale;

}

if(siteID != null){
urlForProductDetails = urlForProductDetails+“&SiteID=”+siteID;

}

if(productID != null){
urlForProductDetails = urlForProductDetails+“&productID=”+productID;

}

var loadProductDatalframe = function( ){
$(“body”).append(‘<iframe id=“i1” src=“‘+urlForProductDetails+’” width=“0” height=“0”
style=“visibility:hidden”></iframe>’);

};

return{
registerOnProductJSON : function(func){
if(!requestedForLoad){
requestedForLoad = true;
loadProductDatalframe( );

}

if(!productJSONLoaded){
listofProductDetailsFunctions.push(func);
}else{
func(productJSON);
}
},
onProductLoad : function(productDetails){
eval(‘productJSON = productDetails’);
productJSONLoaded = true;
for (var i = 0; i < listofProductDetailsFunctions.length; i++) {
listofProductDetailsFunctions[i](productJSON);

}
}
}

```
})( );
</script>
<script>
pageData.requisition = (function( ){
var requisitionJSON;
var requisitionJSONLoaded = false;
var listofRequisitionDataFunctions = [ ];
var requestedForRequisitionLoad = false;
var hostName = “<bean:write name=“request” property=“serverName” filter=“true”/>”;
var portNumber = “<bean:write name=“request” property=“serverPort” filter=“true”/>”;
var protocol = “<bean:write name=“request” property=“scheme” filter=“true”/>”;
var environment = “<bean:write name=“jsEnv” filter=“true” ignore=“true”/>”;
var locale = “<bean:write name=“jsLocale” filter=“true” ignore=“true”/>”;
var siteID = “<bean:write name=“jsSiteID” filter=“true” ignore=“true”/>”;
var requestID = “<bean:write name=“jsReqID” filter=“true” ignore=“true”/>”;
var pageId = “<bean:write name=“jsId” filter=“true” ignore=“true”/>”;
var url = protocol +“://”+hostName
+“:”+portNumber+“/store?Action=DisplayRequisitionDetailsJSONPage”;
if(environment != null){
  url = url+“&Env=”+environment;
}
if(locale != null){
url = url+“&Locale=”+locale;
}
if(siteID != null){
url = url+“&SiteID=”+siteID;
}
if(pageid != null){
url = url+“&id=”+pageID;
}
if(requestID != null){
url = url+“&reqID=”+requestID;
}
var loadRequisitionlframe = function( ){
        $(“body”).append(‘<iframe id=“iframe” src=“’+url+‘”width=“0” height=“0”
style=“visibi1ity:hidden”></iframe>’);
};
return{
registerOnRequisitionJSON : function(func){
if(!requestedForRequisitionLoad){
requestedForRequisitionLoad = true;
loadRequisitionlframe( );
}
if(!requisitionJSONLoaded){
listofRequisitionDataFunctions.push(func);
}else{
func(requisitionJSON);
  }
},
onReqLoad : function(requisitionDetails){
eval(‘requisitionJSON = requisitionDetails’);
requisitionJSONLoaded = true;
for (var i = 0; i < listofRequisitionDataFunctions.length; i++) {
listofRequisitionDataFunctions[i](requisitionJSON);
}
    }
  }
})( );
</script>
</logic:notEmpty>
</dr:page>
```

TABLE 6
Runtime for Add-On

```
<?xml version=“1.0” encoding=“UTF-8”?>
<PluginConfigurationRuntime
  xmlns=“http://extensibility.digitalriver.com/
  PluginConfigurationRuntime”
xmlns:xsi=“http://www.w3.org/2001/XMLSchema-instance”>
  <ConfigurationRuntime>
    <page>ProductDetailsPage</page>
    <styles/>
    <scripts/>
    <bootstrap><![CDATA[$(“#” +
this.id).append(‘@EXT_AddThis_SocialPlugins_Script@’).-
width(@EXT_AddThis_SocialPlugins_Width@).height(
@EXT_AddThis_SocialPlugins_Height@);]]></bootstrap>
    <selector><![CDATA[html body div div#dr_ProductDetails.-
dr_Content div#dr_purchaseDetails form]]></selector>
    <height>25</height>
    <width>400</width>
    <css/>
  </ConfigurationRuntime>
</PluginConfigurationRuntime>
```

In general, two methods are used to create display add-ons and integration add-ons (or a display add-on with an integration component). These are illustrated in the flow charts in After the content manager selects the add-on, the logo image is retrieved from the add-on provider. A PluginConfiguration is created using PluginConfiguration.xsd and PluginConfigurationRuntime using PluginConfigurationRuntime.xsd. A sql script is automatically generated to insert PluginConfiguration and PluginConfigurationRuntime into commerce system tables.

For a feed (integration) add-on, or a display add-on with an integration component, the logo image is retrieved from the add-on provider. A PluginConfiguration is created using PluginConfiguration.xsd and PluginConfigurationRuntime using PluginConfigurationRuntime.xsd. PluginConfiguration will also have PluginIntegration information that will be required to setup integration ProcessConfiguration and ProcessConfigurationVersion which will be used to deliver backend data to the third party recipient using integration services jobs. A generic layout is created with tokens that will be replaced with actual values while configuring add-on and setting layout for selected sites. A sql script is created to insert PluginConfiguration, PluginConfigurationRuntime and layout references in the created tables.

It is to be understood that even though numerous characteristics and advantages of various embodiments of the present invention have been set forth in the foregoing description, together with details of the structure and function of various embodiments, this disclosure is illustrative only, and changes may be made in detail, especially in matters of structure and arrangement of parts within the principles of the present invention to the full extent indicated by the broad general meaning of the terms in which the appended claims are expressed. For example, the particular properties of a token may vary depending on the particular application, while maintaining substantially the same functionality without departing from the scope and spirit of the present invention.

What is claimed is:

1. An online e-commerce self-service system comprising:
a data base comprising add-on features designed to provide small functions to enhance a web page;
an add-on management module comprising interfaces for selecting and configuring add-on features for inclusion on merchant web sites;
a page creation module operatively configured to dynamically generate pages for display to a shopper based on configuration data;
a data structure creation module operatively configured to dynamically generate data structures for the configured page, and inserting the table into a data collection database.

2. The system of claim 1 further comprising:
an integration services module operatively configured to dynamically create data feeds and schedule batch jobs or API transmissions according to configuration requirements of the add-on.
